(19) United States
(12) Patent Application Publication
(10) Pub. No.: US 2015/0258589 A1
(43) Pub. Date: Sep. 17, 2015

(54) TREATMENT OF CONTAMINATED SOIL AND WATER

(71) Applicant: PeroxyChem, LLC, Philadelphia, PA (US)

(72) Inventor: Alan George Seech, Laguna Niguel, CA (US)

(73) Assignee: PeroxyChem, LLC, Philadelphia, PA (US)

(21) Appl. No.: 14/656,962

(22) Filed: Mar. 13, 2015

Related U.S. Application Data
(63) Continuation of application No. 61/953,373, filed on Mar. 14, 2014.

(51) Int. Cl. B09C 1/00; B09C 1/10; C02F 1/28; B09C 1/08; C02F 1/70; C02F 1/52

(52) U.S. Cl. CPC B09C 1/002; C02F 1/705; C02F 1/5263; C02F 1/5236; C02F 1/286; C02F 1/281; B09C 1/08; B09C 1/10; C02F 2101/36

(57) ABSTRACT

The present invention relates to a method of remediating an environmental medium which is contaminated with a halogenated organic contaminant and/or a heavy metal comprising treating such medium with an effective amount of zero valent iron particles and hydrolyzed feather meal.

### CROSS REFERENCE TO RELATED APPLICATIONS

This application claims the benefit of the filing date of U.S. Provisional Application No. 61/953,373, which was filed Mar. 14, 2014. For the purpose of any U.S. application or patent that claims the benefit of U.S. Provisional Application No. 61/953,373, the content of that earlier filed application is hereby incorporated by reference in its entirety.

### FIELD OF THE INVENTION

The present invention relates to a method of remediating an environmental medium which is contaminated with a halogenated organic contaminant and/or a heavy metal comprising treating such medium with an effective amount of zero valent iron (ZVI) particles and hydrolyzed feather meal.

### BACKGROUND OF THE INVENTION

The contamination of subsurface soils and groundwater by halogenated organic compounds and/or heavy metals is a well-documented problem. Many such halogenated contaminants migrate through soil under the influence of gravity to contaminate groundwater as the water passes through the contaminated soil. Notable among these are halogenated organic compounds including volatile organic compounds (or VOCs) which include any at least slightly water soluble chemical compound of carbon, with a Henry's Law Constant greater than 10⁻⁷ atm m³/mole, which is toxic or carcinogenic, is capable of moving through the soil under the influence of gravity and serving as a source of water contamination by dissolution into water passing through the contaminated soil due to its solubility.

The discharge of halogenated contaminants such as VOCs, pesticides and other materials into soil leads to contamination of aquifers and degrades groundwater resources for future use. Treatment and remediation of soils contaminated with VOCs, and/or related materials, is expensive and is often unsuccessful. Remediation of soils containing contaminants which are partially or completely immiscible with water is particularly difficult.

The contamination of subsurface soils and water with naturally occurring heavy metals such as arsenic, selenium, chromium and zinc is a well-documented problem, due to the toxic and/or carcinogenic effects of such compounds. Naturally occurring heavy metals, increased amounts of which may be present due to human activities, can contaminate groundwater as the water passes through contaminated soil. Such contaminant may then be transported into drinking water sources, lakes, and rivers from such groundwater.

The art has attempted to address remediation of soil and groundwater contaminated with halogenated organic contaminants in several different ways. Among the more effective treatments proposed are those in U.S. Pat. Nos. 5,441,664 and 6,083,394 which describe a process for the removal of halogenated chemical contaminants from environmental media which comprises mixing fibrous plant-derived materials with certain multivalent metal particles into the soil: followed by incubating the mixture under conditions which are suitable for anaerobic or facultative anaerobic microorganisms, the growth of which promote anaerobic conditions which lowers the redox potential of the environment. The growth of such anaerobic microorganisms creates strong reducing conditions which are conducive to reductive dehalogenation reactions. It is theorized that this redox potential is further lowered by reducing compounds such as sulfur-containing amino acids and the like which may be present in the organic matter and also by the reducing power of the multivalent metal particles. These publications stress the importance of the fibrous nature of the organic material, indicating that the use of such materials permits absorption of the halogenated chemical contaminants into their structure, increasing the extent of their removal from the environment.

This theory, however, appears questionable in light of the publication of Deng et al. (2002) “Trichloroethylene reduction on zero valent iron: Probing reactive versus nonreactive sites”, Chapter 13, in Innovative Strategies for the Remediation of Chlorinated Solvents and DNAPLs in the Subsurfaces, Susan Henry, Ed., ACS book series, pp 181-205. Deng et al indicate that reduction of trichloroethylene on zero-valent iron is dramatically decreased by the presence of cysteine even at concentration of less than 1 mM. Accordingly, one would expect that the use of organic materials having a high cysteine concentration would similarly adversely affect the dehalogenation of halogenated organic materials in systems employing zero valent iron.

The art has attempted to address remediation of soil and groundwater contaminated with heavy metals through a variety of methods which, in general, are different than those used to remediate environmental media contaminated with organic pollutants. The approaches to remediating such heavy metals typically involve precipitation or other means to convert soluble forms of such heavy metals into relatively insoluble forms. Among the methods which have been proposed is the precipitation of water soluble metal arsenates, particularly of calcium, magnesium and iron (III) arsenates. However, Magalhaes, Arsenic. An environmental problem limited by solubility. Pure Appl. Chem. Vol. 74, No. 10, pp. 1843-1850 (2002), concludes that such methods are “unlikely to produce aqueous solutions with arsenic concentrations below the guideline values proposed for arsenic dissolved in potable water and treated sewage effluents” (Abstract).

Accordingly, there remains a need for a method of remediating environmental media containing soluble heavy metals. It would be desirable if such method could additionally aid in the remediation of halogenated contaminants, as this would permit both such types of contaminants to be treated in a single process.

It has now been unexpectedly found that treating contaminated media with multivalent iron particles and hydrolyzed feather meal—a composition known to have high cysteine content—will result in both increased dehalogenation of halogenated pollutants as well as the conversion of soluble heavy metals to a less soluble form.

### SUMMARY OF THE INVENTION

The present invention is directed to a method of remediating an environmental medium which is contaminated with a halogenated organic contaminant and/or a heavy metal comprising treating such medium with an effective amount of zero valent iron particles and hydrolyzed feather meal.

### DESCRIPTION OF THE PREFERRED EMBODIMENTS

The present invention is directed to a method for the treatment of an environmental medium contaminated with halogenated organic contaminants and/or heavy metals comprising treating such medium with an effective amount of hydrolyzed feather meal and ZVI particles. Specifically, the hydrolyzed feather meal and zero valent metal are added in amounts effective to promote the reductive dehalogenation of halogenated organic compounds and/or to convert soluble heavy metals to relatively insoluble materials.

As is employed herein, the term “heavy metals” means transition metals, and other metals and metalloids in Period 4 or higher of the Periodic Table. Heavy metals which are environmentally undesirable and which may be immobilized by the process of this invention include selenium, arsenic, vanadium, chromium, cadmium, lead, nickel and mercury. The process is particularly useful for the immobilization of selenium, arsenic, vanadium, and chromium.

Halogenated contaminants which may be remediated include chlorinated solvents such as trichloroethylene, vinyl chloride, tetrachloroethylene, methylene chloride, 1,2-dichloroethane, 1,1,1-trichloroethane, 1,1-dichloroethane, 1,1-dichloroethene, carbon tetrachloride, chloroform, chlorobenzenes, and other compounds such as ethylene dibromide. Halogentated pesticidal materials may also be remediated employing the process of this invention.

The environmental media which may be remediated by the method of this invention include soil, sediment, clay, rock, and the like (hereinafter collectively referred to as “soil”), groundwater (i.e., water found underground in cracks and spaces in soil, sand and rocks), process water (i.e., water resulting from various industrial processes) and wastewater (i.e., water containing domestic or industrial waste). In addition, the method of this invention may be used to treat sludges, sands or tars.

Hydrolyzed feather meal (also known as “HFM”) is a byproduct of processing poultry which is made from poultry feathers, primarily chicken feathers, by partially hydrolyzing them under elevated heat and pressure, and then grinding and drying. In general, hydrolyzed feather meal, which contains a high cysteine content, is employed as a nitrogen source for animal feed (mostly ruminants) or as an organic fertilizer.

The feather meal is preferably cut or ground into small particles in order to increase the exposed surface area and thereby enhance its contact with the soil components. The particle size of the feather meal is not, per se, critical to the invention provided that it can be readily mixed with the contaminated soil and is generally in a thickness range of from 0.001 mm to 25 mm. The feather meal particles may be applied to the contaminated environment at a dosage rate of 0.5% to 50% w/w environmental medium (e.g., dry soil, dry sediment or water).

The ZVI employed in the practice of this invention is typically employed in particulate form, with such particles having average diameters ranging from 0.001 mm to 5 mm. The zero valent iron is typically applied at a rate of 50 mg to 5,000 mg per kg of water or kg of dry weight of environmental medium; and is preferably employed at a rate of 250 mg to 2,500 mg per kg of water or kg of dry weight of environmental medium.

Typically, the weight ratio of zero valent iron particles to hydrolyzed feather meal ranges from 1:1 to 1:500,000; preferably the weight range of zero valent iron particles to feather meal is in the range of from 1:1 to 1:10,000.

Microorganisms which are known to dehalogenate and/or degrade halogenated organic chemical contaminants including their byproducts may optionally be added to further enhance the degradation reactions. Effective concentrations of such organisms typically range from 10² to 10⁹ cells per kg water or kg of dry weight of environmental medium.

The method of the present invention may be carried out in situ or ex situ. In situ treatment is conducted in the physical environment where the contaminant(s) are found. Ex situ treatment involves removal of the contaminated medium from the location where it is found and treatment at a different location.

The hydrolyzed feather meal and zero valent iron particles may be added in combination or sequentially by means well known to one of ordinary skill in the art.

In certain embodiments of the present invention a mixture of hydrolyzed feather meal and zero valent iron particles (and, if desired, microorganisms) is pre-incubated to enhance the initial reducing power of the mixture and provide higher microbial content before introduction into the contaminated environment. This embodiment is particularly advantageous for treating contaminated environments in which the contaminants are toxic to microorganisms by increasing the content of desired microbial species prior to introduction into the contaminated environment.

The method of this invention may involve the use of a permeable reactive barrier such as that described in U.S. Pat. No. 7,347,647. In such embodiments, the compositions are made into a pre-shaped, compressed form used to form a permeable reactive barrier for decontamination of soils, sediments, sludges, and waters containing halogenated organic environmental pollutants. The compressed mixture, comprising the hydrolyzed feather meal and zero valent iron particles, is formed into reactive pellets, granules, and other pre-shaped structures for use in constructing a reactive barrier.

### EXAMPLES

The following examples are provided to illustrate the invention in accordance with the principles of this invention, but are not to be construed as limiting the invention in any way except as indicated in the appended claims.

### Example 1

An experiment was conducted to evaluate the ability of various treatments to support dehalogenation of chlorinated solvents, which are among the most common toxic contaminants in soil and groundwater. Chemical parameters known to influence reductive dehalogenation processes, including pH, redox potential (ORP) and the supply of organic carbon (TOC) were also monitored. The experimental unit consisted of one glass column (2″ inside diameter and 24″ length) packed with soil (1,419 g) and connected in series to two glass microcosms (4″ diameter and 12″ length) packed with the same soil (2,450 g). The glass column and the first microcosm were subjected to treatments imposed by mixing amendments (13.4 g for the columns and 24.5 g for the microcosms) into the soil. The amendments were composed of 60% by weight of the organic material indicated (8.0 g for the column, 14.5 g for the microcosm) and 40% by weight ZVI (5.4 g for the column, 14.5 g for the microcosm). The second glass microcosm received no treatment and served as a medium in which the contaminants would have additional time under the influence of the treatments (i.e., the microbial population stimulated by the organic portion of the amendments, ferrous iron released during iron corrosion, minerals formed from iron corrosion products). Water containing trichloroethene (TCE) at a concentration of 5,000 μg/L, one of the most common toxic contaminants in groundwater, was then pumped through the columns and the microcosms at a uniform flow rate (60 mL/day). A control column that received no treatment (i.e., no amendment was added to the soil) was also established and maintained under the same conditions as the treatment columns. Water samples were collected from the outlet of the second glass microcosm and submitted for analysis. The results of this experiment are presented in Table 1.

TABLE 1
Influence of treatments on TCE concentrations, total
organic carbon, redox potential, and pH.

| | | | ZVI + wheat | ZVI + |
|---|---|---|---|---|
| Parameter | Time | | milling | hydrolyzed |
| (units) | (days) | Feed | byproducts | feather meal |
| Total cVOCs | 8 | 5,720 | 336 | 6.4 |
| (μg/L) | 35 | 5,410 | 2,859 | 1,714 |
| | 49 | 5,367 | 2,819 | 2,114 |
| | 64 | 5,099 | 2,974 | 1,934 |
| | 78 | 5,044 | 3,646 | 1,701 |
| | 93 | 4,682 | 3,846 | 1,496 |
| | 106 | 5,033 | 3,802 | 1,850 |
| TOC mg/L) | 8 | 9 | 2,440 | 441 |
| | 35 | 8 | 442 | 974 |
| | 49 | 6 | 74 | 411 |
| | 64 | 7 | 49 | 116 |
| | 78 | 7 | 39 | 131 |
| | 90 | 8 | 32 | 62 |
| | 104 | 8 | 30 | 37 |
| ORP (mV) | 8 | 369 | −80.4 | −124 |
| | 35 | 444 | −131 | −146 |
| | 49 | 434 | −123 | −151 |
| | 64 | NA | NA | NA |
| | 78 | 455 | −108 | −141 |
| | 94 | 394 | −109 | −136 |
| pH (SI units) | 8 | 7.2 | 6.0 | 6.7 |
| | 35 | 7.2 | 6.6 | 6.9 |
| | 49 | 7.1 | 6.6 | 7.0 |
| | 64 | NA | NA | NA |
| | 78 | 7.1 | 6.6 | 7.1 |
| | 94 | 7.2 | 6.5 | 7.0 |

The results indicate that the soil amended with ZVI+hydrolyzed feather meal supported substantially greater removal of chlorinated solvents (cVOC) (63%) than that amended with ZVI+wheat milling byproducts (24%). Also worthy of note is that the chemical conditions observed in water pumped through the column amended with hydrolyzed feather meal were more conducive to reductive dehalogenation reactions than the conditions in the column amended with wheat milling byproducts, with more negative ORP (average of −140 mV as compared to −110 mV, over a period of 94 days) and higher pH (average of 7.0 as compared to 6.5). Further, total organic carbon was released in a more consistent manner by the hydrolyzed feather meal than by the wheat milling byproduct. For example on day 8 of the experiment TOC in effluent from the column treated with hydrolyzed feather meal was 441 mg/L while the TOC in water exiting the column treated with wheat milling byproducts was 2,440 mg/L; however, by day 78 the TOC in the former had fallen to 39 mg/L while that in the latter was more than three-fold higher at 131 mg/L. This more stable organic carbon supply is believed to be more supportive of stable microbial growth and activity of bacteria involved in dehalogenation reactions.

### Example 2

An experiment was conducted to evaluate the ability of various treatments to support dehalogenation of TCE. Chemical parameters known to influence reductive dehalogenation processes, including pH, redox potential (ORP) and the supply of organic carbon (TOC) were also monitored. The design of this experiment was based on glass microcosms containing soil (200 g) to which treatments were applied, by mixing amendments (2.0 g) into the soil. The amendments were composed of 60% by weight of the organic material indicated (1.2 g) and 40% by weight ZVI (0.8 g for the microcosm). Water (855 g), containing TCE (5,000 μg/L), was then added to the microcosms. A control microcosm that received no treatment (i.e., no amendment was added to the soil) was also established and maintained under the same conditions as the treatment microcosms. All microcosms were incubated for 63 days at room temperature. The results of this experiment are presented in Table 2 and they indicate that the reagent composed of ZVI+hydrolyzed feather meal supported the greatest removal of TCE, maintained a higher pH, and generated stronger reducing conditions.

TABLE 2
Influence of treatments on pH, ORP, and TCE
concentration in soil after 63 days incubation.

| Treatment | pH | ORP | TCE (mg/L) |
|---|---|---|---|
| None (control) | 6.6 | 78 | 3,050 |
| ZVI + wheat milling | 6.4 | −115 | 2,474 |
| byproduct | | | |
| ZVI + hydrolyzed | 6.7 | −140 | 5 |
| feather meal | | | |

### Example 3

A microcosm experiment was conducted to evaluate the ability of various treatments to support removal of the heavy metals arsenic and chromium. The experiment involved spiking the heavy metals into soil, allowing a 21 day aging period, then subjecting the soil to treatments designed to support removal of the toxic heavy metals from solution through adsorption and/or precipitation reactions. The design of this experiment was based on glass microcosms containing soil (200 g) to which treatments were applied by mixing amendments (2.0 g) into the soil. The amendments were composed of 60% by weight of the organic material indicated (1.2 g) and 40% by weight ZVI (0.8 g for the microcosm). Water (855 g), containing TCE (5,000 μg/L), was then added to the microcosms. A control microcosm that received no treatment (i.e., no amendment was added to the soil) was also established and maintained under the same conditions as the treatment microcosms. The US EPA standard acid leaching test (Toxicity Characteristic Leaching Protocol, TCLP) was employed to determine the influence of the various treatments on leaching of metals as compared to the control. The results of this experiment are presented in Table 3. They indicate that the reagent composed of ZVI+hydrolyzed feather meal supported greater removal of arsenic, chromium, zinc, and selenium than the reagent composed of ZVI+wheat milling byproduct.

TABLE 3
Influence of soil treatments on leachable concentration in of
heavy metals in soil after 21 days incubation.

| | Arsenic | Chromium | Zinc | Selenium |
|---|---|---|---|---|
| Treatment | (μg/L) | (μg/L) | (μg/L) | (μg/L) |
| None (control) | 20,400 | 44,000 | 830 | 57,900 |
| ZVI + wheat milling | 450 | 920 | 760 | 16,500 |
| byproduct | | | | |
| ZVI + hydrolyzed | 140 | 470 | 620 | 12,800 |
| feather meal | | | | |

What is claimed is:

1. A method for the treatment of an environmental medium contaminated with halogenated organic contaminants and/or heavy metals comprising treating such medium with an effective amount of hydrolyzed feather meal and zero valent iron particles.

2. The method of claim 1 wherein said environmental medium is selected from the group consisting of soil, groundwater, process water and wastewater.

3. The method of claim 1 wherein said halogenated organic contaminant is selected from the group consisting of trichloroethylene, vinyl chloride, tetrachloroethylene, methylene chloride, 1,2-dichloroethane, 1,1,1-trichloroethane, 1,1-dichloroethane, 1,1-dichloroethene, carbon tetrachloride, chloroform, chlorobenzenes, ethylene dibromide and halogentated pesticidal materials.

4. The method of claim 1 wherein said heavy metal is selected from the group consisting of selenium, arsenic, vanadium, chromium, cadmium, lead, nickel and mercury

5. The method of claim 1 wherein the zero valent iron is in the form of particles having an average diameter of between 0.001 mm and 5 mm.

6. The method of claim 5 wherein the zero valent iron particles are added in a dosage range from 50 mg to 5000 mg per kg of water or dry weight of environmental medium.

7. The method of claim 6 wherein the zero valent iron particles are added in a dosage range from 250 mg to 2500 mg per kg of water or dry weight of environmental medium.

8. The method of claim 1 wherein the environmental medium is treated with a composition comprising a mixture of hydrolyzed feather meal and zero valent iron particles wherein the weight ratio of zero valent iron particles:feather meal in the mixture ranges from 1:1 to 1:500,000.

9. The method of claim 8 wherein the environmental medium is treated with a composition comprising a mixture of hydrolyzed feather meal and zero valent iron particles wherein the weight ratio of zero valent iron particles:feather meal in the mixture ranges from 1:1 to 1:10,000.

10. The method of claim 1 wherein the hydrolyzed feather meal is added at a dosage range from 0.5% to 50% w/w environmental medium.

11. The method of claim 1 wherein the hydrolyzed feather meal is ground or cut into particles having a thickness ranging from 0.001 mm to 25 mm.

12. The method of claim 1 wherein the environmental medium is further treated with one or more supplemental microorganisms which are capable of dehalogenating and/or degrading the halogenated organic compounds.

13. The method of claim 12 wherein the supplemental microorganism concentration is in the range from 10² to 10⁹ cells per kg water or dry weight of environmental medium.

14. The method of claim 12 wherein supplemental microorganisms which are capable of degrading and/or dehalogenating the organic contaminants are mixed with the organic matter and zero valent iron and incubated before addition to the contaminated environmental medium.

15. The method of claim 12 wherein the supplemental microorganism concentration is in the range from 10² to 10⁹ cells per kg water or dry weight of environmental medium.

16. The method of claim 1 wherein the hydrolyzed feather meal and zero valent iron particles are mixed and incubated before addition to the environmental medium.

17. The method of claim 1 wherein the environmental medium is treated in situ.

18. The method of claim 1 wherein the environmental medium is treated ex situ.

19. The method of claim 5 wherein the hydrolyzed feather meal and zero valent iron particles are compressed and incorporated into a permeable reactive barrier.
